(19) United States
(12) Patent Application Publication
(10) Pub. No.: US 2012/0032885 A1
(43) Pub. Date: Feb. 9, 2012

(54) REVERSING ACTIONS

(75) Inventor: Adam Paul Miller, Berkshire (GB)

(73) Assignee: NOKIA CORPORATION, Espoo (FI)

(21) Appl. No.: 12/849,421

(22) Filed: Aug. 3, 2010

(51) Int. Cl. G06F 3/02

(52) U.S. Cl. 345/168

(57) ABSTRACT

An apparatus and method for receiving a first user input performed on a user interface element; determining, in a first determination, that the first user input is of a first type; performing an action associated with the user interface element, in response to said first determination; receiving a second user input on the user interface element; determining, in a second determination, that the second user input is of a second type, the second type being different to the first type; and reversing the action, in response to the second determination.

### TECHNICAL FIELD

The present application relates generally to the performance of actions in response to a user input, and the reversal of such actions.

### BACKGROUND

Many electronic devices are configured to perform actions in response to the reception of user inputs made on user interface elements. However, not all such user inputs are deliberate, and even deliberate user inputs may be erroneous.

### SUMMARY

According to a first example embodiment, there is provided a method comprising: receiving a first user input performed on a user interface element; determining, in a first determination, that the first user input is of a first type; performing an action associated with the user interface element, in response to said first determination; receiving a second user input on the user interface element; determining, in a second determination, that the second user input is of a second type, the second type being different to the first type; and reversing the action, in response to the second determination.

According to a second example embodiment, there is provided an apparatus comprising: a processor; and memory including computer program code, the memory and the computer program code configured to, working with the processor, cause the apparatus to perform at least the following: receive a first user input performed on a user interface element; determine, in a first determination, that the first user input is of a first type; perform an action associated with the user interface element, in response to said first determination; receive a second user input on the user interface element; determine, in a second determination, that the second user input is of a second type, the second type being different to the first type; and reverse the action, in response to the second determination.

According to a third example embodiment, there is provided an apparatus comprising the apparatus of the second example embodiment.

According to a fourth example embodiment, there is provided a computer program product comprising a computer-readable medium bearing computer program code embodied therein for use with a computer, the computer program code comprising: code for receiving a first user input performed on a user interface element; code for determining, in a first determination, that the first user input is of a first type; code for performing an action associated with the user interface element, in response to said first determination; code for receiving a second user input on the user interface element; code for determining, in a second determination, that the second user input is of a second type, the second type being different to the first type; and code for reversing the action, in response to the second determination.

According to a fifth example embodiment, there is provided a computer-readable medium encoded with instructions that, when executed by a computer, perform the following: receiving a first user input performed on a user interface element; determining, in a first determination, that the first user input is of a first type; performing an action associated with the user interface element, in response to said first determination; receiving a second user input on the user interface element; determining, in a second determination, that the second user input is of a second type, the second type being different to the first type; and reversing the action, in response to the second determination.

According to a sixth example embodiment, there is provided an apparatus comprising: means for receiving a first user input performed on a user interface element; means for determining, in a first determination, that the first user input is of a first type; means for performing an action associated with the user interface element, in response to said first determination; means for receiving a second user input on the user interface element; means for determining, in a second determination, that the second user input is of a second type, the second type being different to the first type; and means for reversing the action, in response to the second determination.

### BRIEF DESCRIPTION OF THE DRAWINGS

For a more complete understanding of example embodiments of the present invention, reference is now made to the following descriptions taken in connection with the accompanying drawings in which:

FIG. 1 is an illustration of an apparatus;

FIG. 2 is an illustration of a keypad that may be comprised by the apparatus of FIG. 1;

FIG. 3 is an illustration of a possible operation of a key of the keypad of FIG. 2;

FIG. 4 is an illustration of a different operation of a key of the keypad of FIG. 2;

FIGS. 5a-5f are illustrations of text entry operations performed on an apparatus;

FIGS. 6a-6c are illustrations of text editing operations performed on an apparatus;

FIGS. 7a-7c are illustrations of mode selection operations performed on a flashlight;

FIG. 8 is a flow diagram illustrating a method; and

FIG. 9 is a flow diagram illustrating a method.

### DETAILED DESCRIPTION OF THE DRAWINGS

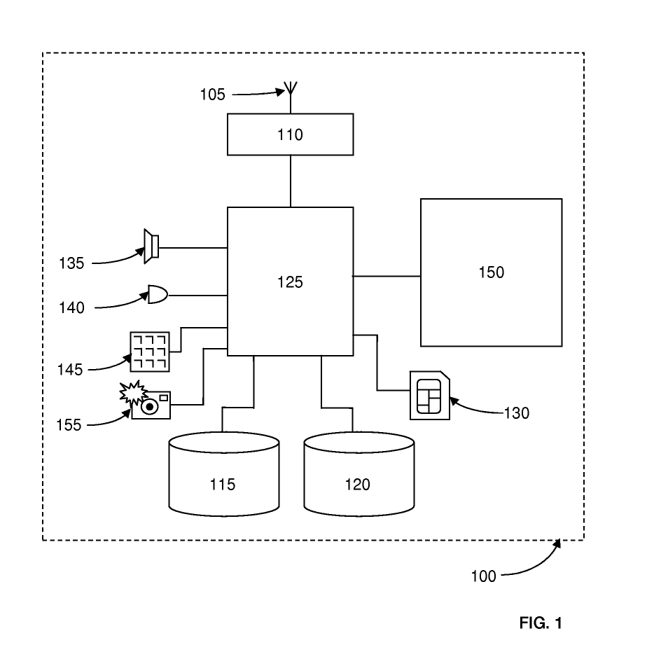

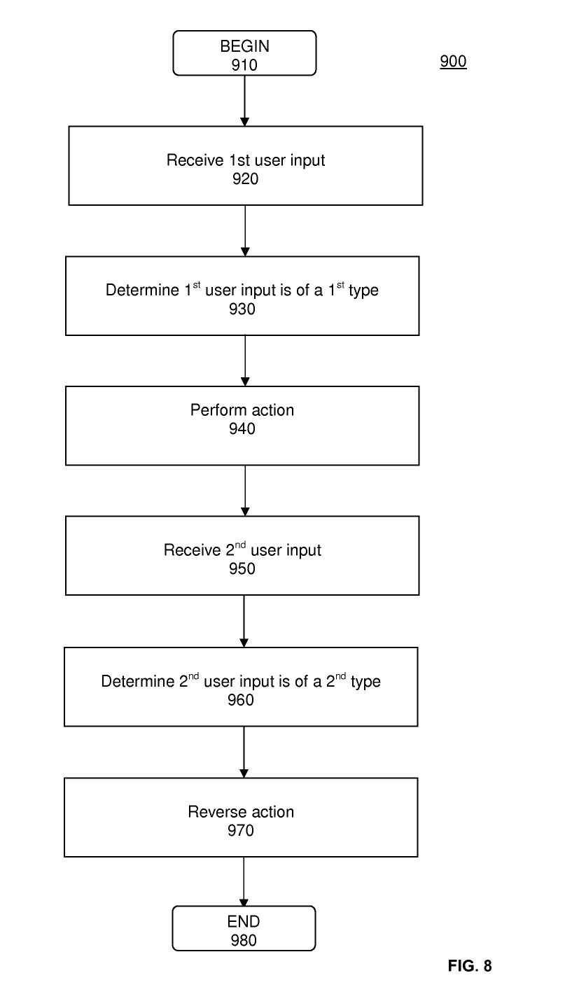

An example embodiment of the present invention and its potential advantages are understood by referring to FIGS. 1 through 10 of the drawings.

FIG. 1 illustrates an apparatus 100 according to an exemplary embodiment of the invention. The apparatus 100 may comprise at least one antenna 105 that may be communicatively coupled to a transmitter and/or receiver component 110. The apparatus 100 also comprises a volatile memory 115, such as volatile Random Access Memory (RAM) that may include a cache area for the temporary storage of data. The apparatus 100 may also comprise other memory, for example, non-volatile memory 120, which may be embedded and/or be removable. The non-volatile memory 120 may comprise an EEPROM, flash memory, or the like. The memories may store any of a number of pieces of information, and data—for example an operating system for controlling the device, application programs that can be run on the operating system, and user and/or system data. The apparatus may comprise a processor 125 that can use the stored information and data to implement one or more functions of the apparatus 100, such as the functions described hereinafter.

The apparatus 100 may comprise one or more User Identity Modules (UIMs) 130. Each UIM 130 may comprise a memory device having a built-in processor. Each UIM 130 may comprise, for example, a subscriber identity module, a universal integrated circuit card, a universal subscriber identity module, a removable user identity module, and/or the like. Each UIM 130 may store information elements related to a subscriber, an operator, a user account, and/or the like. For example, a UIM 130 may store subscriber information, message information, contact information, security information, program information, and/or the like.

The apparatus 100 may comprise a number of user interface components. For example, a microphone 135 and an audio output device such as a speaker 140. The apparatus 100 may comprise one or more hardware controls, for example a plurality of keys laid out in a keypad 145. Such a keypad 145 may comprise numeric (for example, 0-9) keys, symbol keys (for example, #, *), alphabetic keys, and/or the like for operating the apparatus 100. For example, the keypad 145 may comprise a conventional QWERTY (or local equivalent) keypad arrangement. The keypad may instead comprise a different layout, such as E.161 standard mapping recommended by the Telecommunication Standardization Sector (ITU-T). The keypad 145 may also comprise one or more soft keys with associated functions that may change depending on the operation of the device. In addition, or alternatively, the apparatus 100 may comprise an interface device such as a joystick, trackball, or other user input component.

The apparatus 100 may comprise one or more display devices such as a screen 150. The screen 150 may be a touch screen, in which case it may be configured to receive input from a single point of contact, multiple points of contact, and/or the like. In such an embodiment, the touch screen may determine input based on position, motion, speed, contact area, and/or the like. Suitable touch screens may involve those that employ resistive, capacitive, infrared, strain gauge, surface wave, optical imaging, dispersive signal technology, acoustic pulse recognition or other techniques, and to then provide signals indicative of the location and other parameters associated with the touch. A “touch” input may comprise any input that is detected by a touch screen including touch events that involve actual physical contact and touch events that do not involve physical contact but that are otherwise detected by the touch screen, such as a result of the proximity of the selection object to the touch screen. The touch screen may be controlled by the processor 125 to implement an on-screen keyboard.

The apparatus 100 may comprise a media capturing element such as a video and/or stills camera 155.

Not all of the features of the apparatus 100 illustrated in FIG. 1 need be present, and a non-exhaustive list of examples of the apparatus may therefore include may include a mobile telephone, a personal computer, a Personal Digital Assistant (PDA), a games console, a pager, and a digital watch. In some embodiments, the apparatus 100 is a mobile communication device.

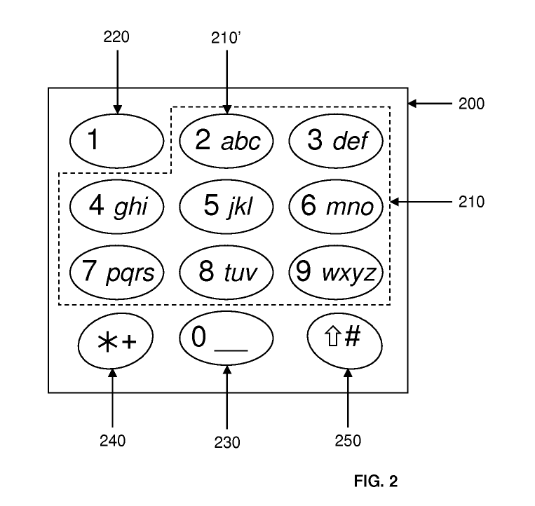

FIG. 2 illustrates an example of a keypad 200 that may be suitable for use in or with the apparatus 100 of FIG. 1. The keypad 500 comprises 12 keys that are mapped to the numbers “0”-“9”, symbols “*” and “#”, and characters “a”-“z” according to the ITU-T E.161 recommendation—although in some embodiments alternative mappings may be used.

There are many different ways in which the keypad 200 of FIG. 2 could be used to input text and numbers into the apparatus 100. These include both ambiguous and unambiguous character entry. An example of unambiguous character entry is the so-called “multi-tap” method of entering text.

On the keypad 200 of FIG. 2 each of the numbers “2”-“9” is mapped to a different key 210, and the letters “a”-“z” are divided amongst these keys 210 so that either 3 or 4 letters is assigned to each key 210. The number “1” is assigned to its own key 220, and the number “0” shares a key 230 with the space character. The character “*” shares a key with the “+” character, and the “#” character shares a key 250 with a capitalisation function (represented by the symbol “□”). Although this mapping of keys will be used in the following description, other mappings may be used in its place.

According to the multi-tap method of text entry, a user can enter a particular character from amongst those assigned to a key by repeatedly activating the key in order to cycle through a sequence of the characters assigned to it until he reaches the one he desires. The character of the sequence that is currently selected may be presented to the user, for example by representing it on the display 150 of the apparatus 100. Once he has reached his desired character, he accepts it in some manner. Suitable methods for accepting the character may include ceasing to activate the key until a predetermined period of time has passed (i.e. a “time-out”), activating a different key, or performing a predetermined other action (e.g. pressing a designating “accept” key).

So, for example, a user wishing to enter the character “c” may repeatedly press key 210′ (which is assigned to the characters “a”, “b”, “c”, and “2”) until the character “c” is presented to him. The characters may be presented in any order, but in some embodiments will be presented in an order that is reflected in a label visible on the key. In the example shown in FIG. 2, the order of the characters is “a”, “b”, c″, and then “2”. In order to enter the character “c”, the user therefore must press key 210′ a first time to select “a”, a second time to advance the selection to “b”, and a third time to further advance the selection to “c”. Once “c” is selected, the user may accept that character for text entry, for example by ceasing to press key 210′ until a predetermined time has expired, or a different key has been pressed.

In some embodiments, characters other than those described above may be mapped to the keys. For example, diacritical marks, currency symbols, and/or punctuation marks may be mapped to the keys in place of or in addition those described.

Some of the apparatuses include a keypad labelled as shown in FIG. 2. However, the sequence of characters that can be accessed by repeatedly pressing the keys includes characters that are not shown in the key label. For example, the “2 abc” key 210′ may be mapped not only to the characters “a”, “b”, “c”, and “2”, but also to the characters “ä”, “à”, “á”, “ã”, “â”, “ [symbol] ”, “æ”, and “ [symbol] ”. In this example, the character “ [symbol] ” is last in the sequence and would therefore be selected by activating key 201′ 12 times in rapid succession.

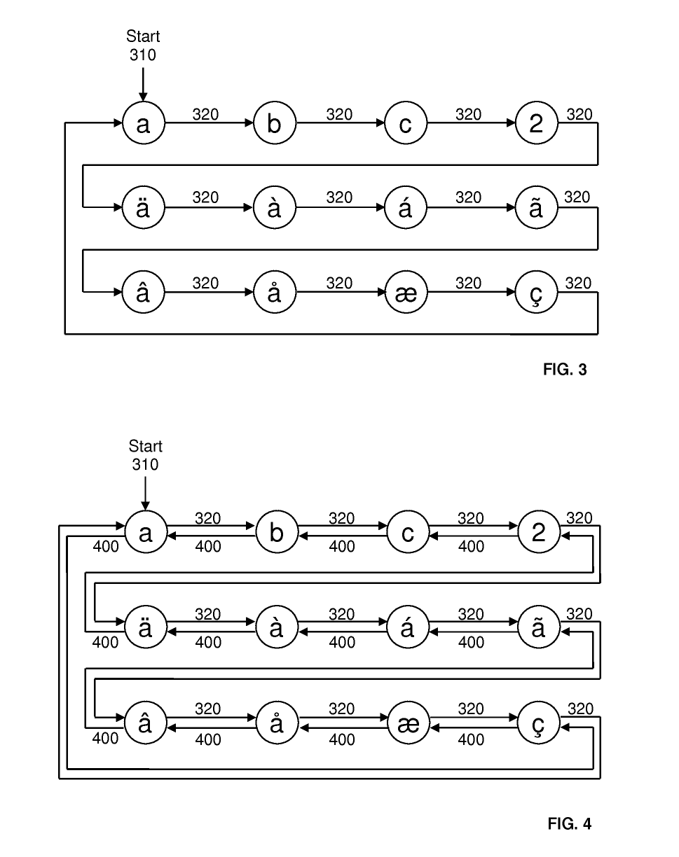

FIG. 3 illustrates the selection of each of the characters “a”, “b”, “c”, “2”, “ä”, “à”, “á”, “ã”, “â”, “ [symbol] ”, “æ”, and “ [symbol] ” by repeatedly activating key 210′. After the first press 310, the character “a” is selected. Each of the arrows labelled 320 represents a successive activation of key 201′. Therefore, the second activation 320 of key 210′ moves the selection to “b”, the third 320 to “c” and so on. After 12 successive key activations the character “ [symbol] ” is selected; at this point the next activation 320 loops the selection back to character “a”—although it is possible that this looping action could be replaced by a different function, for example cancelling the entry of the character, or progressing to the sequence of characters mapped to another key.

It is possible to move through the sequence of mapped characters not only in a forward direction (e.g. “a” to “ [symbol] ” in the example of FIG. 3), but also in a backwards direction (“ [symbol] ” to “a” in the example). This may be useful should the user erroneously make one or more successive activations of the key when selected a character. In the example of key 210′, a single extra activation will have a cost of 11 further key presses to rectify by following a looping sequence around to the intended character. Even where an option exists to cancel the entry of the character and begin again the cost in terms of key presses can be high (especially where the intended character lies many steps into the sequence).

FIG. 4 represents the same sequence as FIG. 3, but illustrates backwards movement of the selection in addition to forwards movement. The selection is moved backwards by activating the key 210′ in a different manner to that required for forward progression, and this activation is illustrated by the arrows labelled 400.

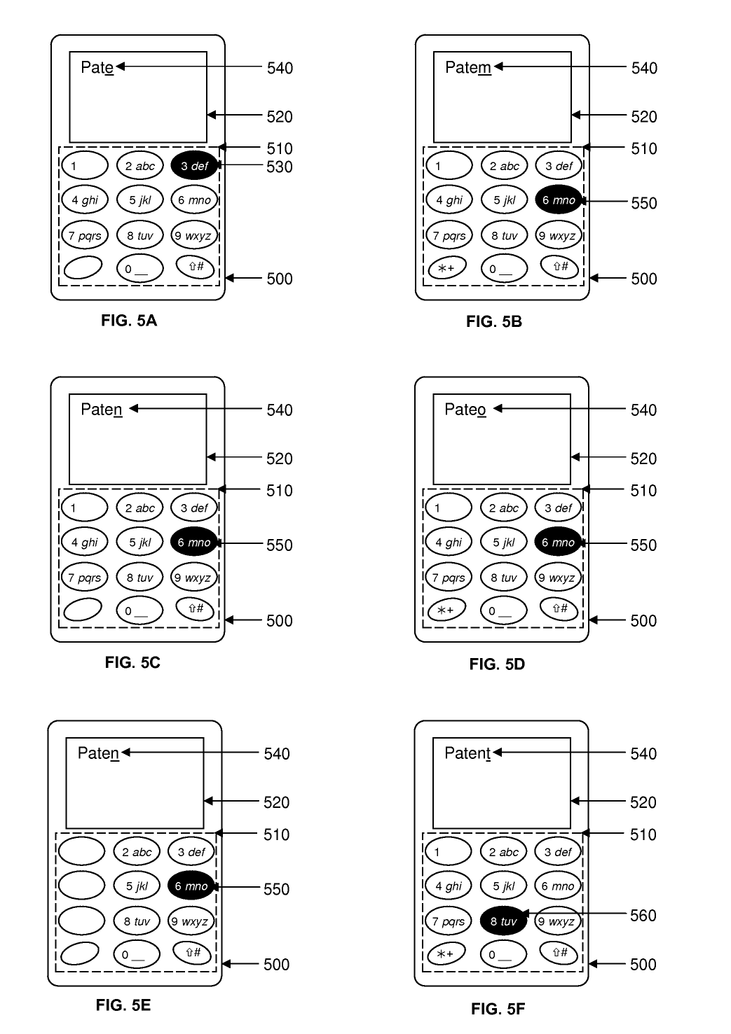

In some embodiments, it is possible to continuously reverse the selection as illustrated in FIG. 5. However, in other embodiments it is only possible to reverse the movement of the selection to the extent that it has already been moved forward. For example, consider the case of three successive forward activations of key 210′ to select the character “c”, followed by four successive reverse activations. In embodiments that permit continuous reversal of the selection the character “æ” would be selected (because the first two reverse activations move the selection back to “a”, after which the sequence loops backwards to “ [symbol] ” and then “æ”. In contrasts, embodiments that do not permit continuous reversal may only permit the sequence to be reversed to the extent that it has previously been progressed—so in this case the sequence could only be reversed as far as “a” (the first selection”). In other embodiments the initial selection of “a” may be reversible (e.g. to a selection of no character, with the effect of cancelling the character input).

In embodiments where the selection may be reversed continuously, it may be possible to enter the sequence at a different position depending on whether the first-received user input is a forward or a reverse activation. For example, FIG. 3 illustrates the first activation as a forward activation 310 that selects the first character in the sequence, character “a”. If the first-received user input had been a reverse activation then the sequence could have been entered at a different point—for example by selecting the last character in the sequence, character “ [symbol] ”. More generally, when the first-received user input is a reverse activation, a different selection may be made from within the sequence than when the first-received input is a forward activation, and this different selection may be the selection of the final item in the sequence.

In order to determine whether to move the character selection forwards or to reverse it, the activation of key 210′ may be examined to determine the type of activation. For example, it may be determined that a short press of key 210′ (one held for less than a threshold time period) is to be interpreted as one of the forward and reverse activations and a long press (held for at least the threshold time period) is to be interpreted as the other activation. Alternatively, a single press of key 210′ (just one press within a predetermined time period) is to be interpreted as one of the forward and backward activations, and a double press (two activations within the time period) is to be interpreted as the other activation. Where it is possible to measure the pressure with which a key is pressed, forward and reverse activations may be distinguished by comparing the pressure of a press to a threshold pressure. It will be understood that any two distinguishable types of activation of a key may be used to differentiate between the forward and reverse activations.

Although the above embodiments have been described with specific reference to the example a key 210′ (which may be a physical key or a virtual key displayed on a touch screen) it will be understood that the same concept may be applied more widely whenever it is possible to distinguish between two types of user input that are performed on a single user interface element.

FIGS. 5a-f illustrates a worked example of the use of reversible character input. In this example, a user is attempting to enter the word “Patent” using a device 500 which is an example of the apparatus 100 of FIG. 1 and includes a keypad 510 similar to that described above in relation to FIGS. 2-4. In FIG. 5a the character “e” has just been entered by the user by making two successive forward activations on the “3 def” key 530 of the keypad 100, and the characters entered so far 540 are displayed on a screen 520 of the device. In this example, a forward activation of a key is achieved using a short press and a reverse activation is achieved using a long press, but as explained above, any two distinguishable types of activation could be used.

In FIG. 5b, the user (desiring to enter the character “n”) has forward activated the “6 nmo” key 550 with a single short press, causing the first of the characters mapped to this key 550 to be selected and displayed on the screen 520. In this example, the sequence of characters mapped to key 550 is “m”, “n”, “o”, “6”, “ö”, “ò”, “ó”, “ô”, “õ”, “ø”, “ñ” and the displayed character is therefore “m”.

In FIG. 5c the user has made a second short press of key 550, advancing the character selection forward to “n”, and the text 540 on the display 520 has been updated.

Although the user has now selected the character he desires (“n”), he now erroneously makes a third short key press of key 550, causing the character selection to be advanced to character “o”, and the text 540 on the display 520 to be updated. This is shown in FIG. 5d.

Rather than delete the current character and start again, or continue to cycle through the 11-character sequence mapped to key 550, the user makes a long key press on key 550, with the effect of reversing the character selection. The selected character therefore changes from “o” back to “n”, as illustrated in FIG. 5e.

Finally, as shown in FIG. 5f, the user presses the “8 tuv” key 560, which has the effect of both approving the selection of the character “n”, and entering a new character “t”. The user has successfully entered the word “Patent”.

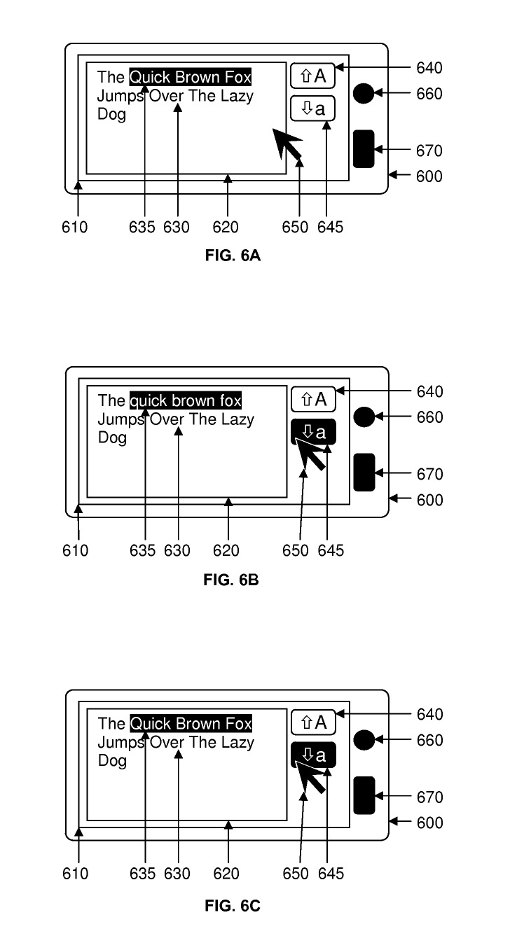

The examples above describe using forward and reverse activations when cycling forwards and backwards through a sequence of characters in the context of text input. However, forward and reverse activations have a more general application in any action that is initiated by user input and that can be reversed. FIGS. 6a-c illustrate an example of such a use case.

In FIG. 6a there is depicted an example device 600 that includes a screen 610. On the screen, the device is displaying a text area 620 which includes a passage of text 630, a portion of which 635 has been highlighted for editing. Also displayed are two virtual buttons 640, 645 that when selected cause the highlighted text to be converted into uppercase letters (button 640) or lowercase letters (button 645). Presently, the highlighted text 635 is written in a mixture of upper and lowercase letters. Finally, the screen 610 also displays a cursor, which the user can use to highlight text 630, or activate the buttons 640, 645. The device also includes a trackball 660 that can be used to move the cursor and a physical button 670 that can be used to perform manipulate user interface elements at a designated hotspot of the cursor (e.g. the tip of the cursor).

In FIG. 6b the user has used the trackball 660 to move the cursor over virtual button 645 (convert to lowercase) and has accidentally pressed the physical button 670. This has had the effect of converting the highlighted portion 635 of the text 630 into lowercase. This is not an easy mistake to remedy, since activating virtual button 645 a second time will have no effect (it converts text to lower case, and the highlighted portion 635 is already all lowercase), and activating virtual button 640 will convert the entire highlighted portion into uppercase (“QUICK BROWN FOX”) and not the mix of upper and lower case that was originally present. It would be possible for the user to highlight each of the letters “q”, “b”, and “f” in turn and use button 640 to convert just these to uppercase—but this is time consuming and laborious, requiring a large number of delicate user input actions.

Fortunately for the user, the device 600 is able to distinguish between forward and reverse user activations of button 645 and by performing a reverse activation the user is able to reverse the action previously performed when button 645 was forward activated. In this particular example, a forward activation corresponds to a single click of physical button 670 when the tip of the cursor is over button 645, and a reverse activation corresponds to a double click of button 670 with the cursor similarly located—but as explained above any differentiable user inputs on button 645 could be assigned to the forward and reverse actions.

In FIG. 6c the user has double clicked physical button 670 with the tip of the curse over virtual button 645, with the effect that the earlier case conversion has been reversed.

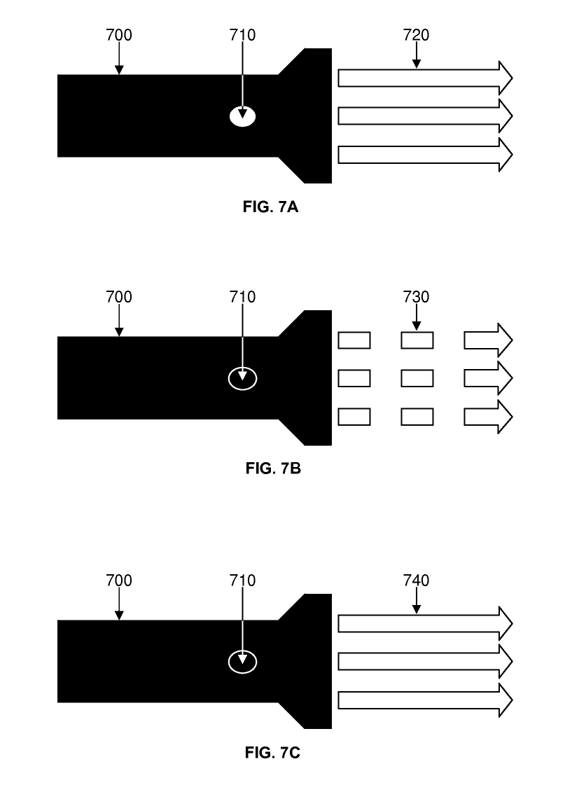

FIGS. 7a-c illustrates another example of a forward action being reversed. It shows a flashlight 700 with a single button 710 provided by means of a user interface. The flashlight 700 is capable of being operated in a number of different modes, including the following:

1. Off

2. Constant low power beam

3. Flashing low power beam

4. Constant high power beam

5. Constant low power beam

The button 710 includes a pressure sensor that allows the flashlight 700 to distinguish between hard and soft presses of the button 710 by comparing the pressure exerted on the button 710 to a threshold value when the button 710 is pressed. Hard presses of the button advance the mode of the flashlight 700 in the order listed above, whilst gentle presses reverse any previous forward movement through the modes. When the torch is in the “off” mode then subsequent light presses will not loop the mode backwards to the “constant low power beam” mode, since if accidentally knocked the flashlight 700 could easily be drained of power; the action reversal is therefore not continuous (as described above).

In FIG. 7a the flashlight 700 is being operated in mode 1, and the beam of light 720 leaving the torch is therefore of constant high low power.

In FIG. 7b button 710 has been lightly pressed by the user, by accident, and the flashlight 700 has therefore switched to mode 2—a flashing low power beam 730.

In FIG. 7c the user has corrected his inadvertent activation of the button 710 by pressing it hard, reversing the previous action to advance from mode 1 to mode 2. The flashlight 700 has therefore reverted to mode 1, and the beam 740 is again constant and low power.

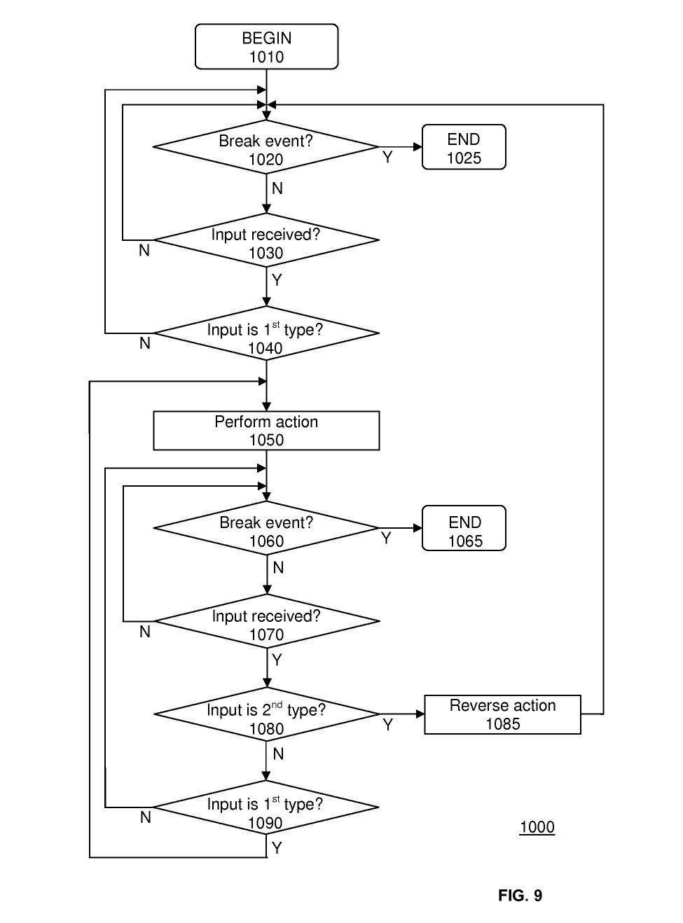

FIG. 9 illustrates an example method 900 of performing a method that implements the above-described behaviour. The method begins at 910, after which a first user input is received 920 on a user interface element. The user interface element may be an element that is capable of only binary operation—e.g. a switch or button that can only be changed between two states. The user interface element may be a key in a keypad, for example a key that is assigned to a plurality of alphanumeric characters for text input purposes.

A determination is made 930 as to the type of the first input. Although the user interface element is in some embodiments capable of only binary operation, it is still possible for the user to activate it in more than one way in order to make user inputs of different types—for example, a button may be held in a short press or a long press as described above. In this case, the first user input is determined to be of a first type.

In response to the determination that the user input is of a first type, an action associated with the first user interface element is performed 940. For example, where the user interface element is a button that is associated with a particular function (e.g. the selection of a character associated with the button), that function is performed in response to the determination that the input made on the user interface element was of the first type.

A second user input 950 is subsequently received on the same user interface element. A new determination is made 960 that the second user input is of a second type, which is different to the first type.

In response to the determination 960 that the second user input is of the second type, the action is reversed 970. Reversing the action may comprise performing an opposite action, or restoring a system to its state immediately before the first action was performed upon it. The method 900 then ends 980.

FIG. 10 illustrates a more complex example of a method 1000 that may be used to provide the functionality described above, illustrating not only the effect of multiple first and/or second inputs, but also the effect of a so-called “break event”.

In some embodiments it may not be desirable that the ability to reverse an action is available only until one or more criteria are satisfied. For example, in the example of text input illustrated in FIG. 4, it may not be desired that the user can reverse the selection of a character after that character has been accepted by the user (e.g. after a timeout or the activation of a different key). Similarly, in the example shown in FIG. 6 it may not be desirable (or even make sense) that the conversion to lowercase can be reversed after certain other editing tasks have been performed (e.g. changing the text 630 or changing the highlighted portion 635). In such cases, the meeting of a criterion or criteria after which the action is deemed non-reversible is referred to as a “break event”. The break event may be the fulfilment of each of a single criterion or set of criteria, or the fulfilment of any one of a number of multiple criteria or sets of criteria, and the choice of break event will depend on the use case.

Method 1000 begins at 1010. The method then checks to see whether a break event has occurred 1020, in which case the method ends 1025. If a break event has not occurred, the method than checks whether or not a user input on a first interface element has been received 1030. If no such input has been received, the method loops back to the start 1010 and continues to check for break events 1020 or user inputs on the first user interface element 1030

If a user input has been received on the user interface element, the method determines whether or not the input is of a first type 1040. If the user input is not of the first type, the method loops back to the start 1010. Conversely, if the user input is determined to be of the first type then an action associated with the user interface element is performed 1050.

After performing the action 1050, the method checks again to see whether a break event has occurred 1060. If a break even has occurred then the method ends 1065. If a break event hasn't occurred, then the method checks to see whether or not a further input on the first user interface element has been received 1070. If no such input has been received, the system loops back and repeatedly checks for break events 1060 or user inputs on the user interface element 1070 until one or the other is received.

If a further user input on the first user interface element is received 1070 then it is determined whether or not the further input is of a second type 1080, the second type being different to the first type. If the further input is of the second type, the previously performed action is reversed 1085 (for example by performing a complimentary action, or otherwise returning a system to the state in which it was immediately before the action was performed) and the method loops back to the start 1010. If, on the other hand, the further input is not of the second type, it is determined whether or not it is of the first type 1090. If the further input is of the first type, then the action associated with the user input element is repeated 1050. In either case, the method 1000 then loops back to the point immediately following the performance of the action 1050 and continues to repeatedly check for break events 1060 or the receipt of a further user input 1070 until one or the other occurs.

Without in any way limiting the scope, interpretation, or application of the claims appearing below, a technical effect of one or more of the example embodiments disclosed herein is that an action performed in response to a user input on a first user input element can easily be reversed by the user by making a second user input, of a different type, on the same user interface element.

Embodiments of the present invention may be implemented in software, hardware, application logic or a combination of software, hardware and application logic. The software, application logic and/or hardware may reside on a removable memory, within internal memory or on a communication server. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with examples of a computer described and depicted in FIG. 1. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. A method comprising:
receiving a first user input performed on a user interface element;
determining, in a first determination, that the first user input is of a first type;
performing an action associated with the user interface element, in response to said first determination;
receiving a second user input on the user interface element;
determining, in a second determination, that the second user input is of a second type, the second type being different to the first type; and
reversing the action, in response to the second determination.

2. The method of claim 1, wherein:
the user interface element is associated with the selection of an option from a set of options;
the action comprises changing the selection from a first option to a second option; and
reversing the action comprises changing the selection back from the second option to the first option.

3. The method of claim 2, wherein the set of options is a set of characters.

4. The method of claim 1, wherein the user interface element is a button.

5. The method of claim 4, wherein the button is a key in an alphanumeric keypad.

6. The method of claim 5, wherein the alphanumeric keypad is a multi-tap keypad.

7. The method of claim 1, wherein the first and second input types are selected from: a long activation of the user input element; and a short activation of the user input element.

8. The method of claim 1, wherein the first and second input types are selected from: a first number of activations of the user input element within a predetermined time period; and a second number of activations of the user input element within a predetermined time period, said first and second numbers both being greater than zero.

9. An apparatus comprising:
a processor; and
memory including computer program code,
the memory and the computer program code configured to, working with the processor, cause the apparatus to perform at least the following:
receive a first user input performed on a user interface element;
determine, in a first determination, that the first user input is of a first type;
perform an action associated with the user interface element, in response to said first determination;
receive a second user input on the user interface element;
determine, in a second determination, that the second user input is of a second type, the second type being different to the first type; and
reverse the action, in response to the second determination.

10. The apparatus of claim 9, wherein:
the user interface element is associated with the selection of an option from a set of options;
the action comprises changing the selection from a first option to a second option; and
reversing the action comprises changing the selection back from the second option to the first option.

11. The apparatus of claim 10, wherein the set of options is a set of characters.

12. The apparatus of claim 9, wherein the user interface element is a button.

13. The apparatus of claim 12, wherein the button is a key in an alphanumeric keypad.

14. The apparatus of claim 5, wherein the alphanumeric keypad is a multi-tap keypad.

15. The apparatus of claim 9, wherein the first and second input types are selected from: a long activation of the user input element; and a short activation of the user input element.

16. The apparatus of claim 9, wherein the first and second input types are selected from: a first number of activations of the user input element within a predetermined time period;
and a second number of activations of the user input element within a predetermined time period, said first and second numbers both being greater than zero.

17. An apparatus comprising the apparatus of claim 9.

18. A computer program product comprising a computer-readable medium bearing computer program code embodied therein for use with a computer, the computer program code comprising:
code for receiving a first user input performed on a user interface element;
code for determining, in a first determination, that the first user input is of a first type;
code for performing an action associated with the user interface element, in response to said first determination;
code for receiving a second user input on the user interface element;
code for determining, in a second determination, that the second user input is of a second type, the second type being different to the first type; and
code for reversing the action, in response to the second determination.
